(19) United States
(12) Patent Application Publication
(10) Pub. No.: US 2014/0300872 A1
(43) Pub. Date: Oct. 9, 2014

(54) DISPLAY DEVICE

(71) Applicant: SAMSUNG ELECTRONICS CO., LTD., Suwon-si (KR)

(72) Inventors: Hak Young KIM, Yongin-si (KR); Jae Geun LIM, Suwon-si (KR); Joon Young JUNG, Yongin-si (KR); Jean HUR, Seongnam-si (KR)

(73) Assignee: SAMSUNG ELECTRONICS CO., LTD., Suwon-si (KR)

(21) Appl. No.: 14/245,008

(22) Filed: Apr. 4, 2014

(30) Foreign Application Priority Data
Apr. 5, 2013 (KR) 10-2013-0037344

(51) Int. Cl. G03B 21/16

(52) U.S. Cl. CPC G03B 21/16
USPC 353/58; 353/52

(57) ABSTRACT

A projection-type display device having an improved structure to effectively cool an optical engine to generate light having image information and project the same onto a screen, and a driving circuit to drive the optical engine are provided.

The display device includes a screen on which an image is formed, a stand to support the screen, an optical engine accommodated in the stand, the optical engine generating light having image information and projecting the light onto the screen, a first heat-radiating plate connected to a rear surface of the screen, and a driving circuit connected to a rear surface of the first heat-radiating plate, the driving circuit driving the optical engine.

### CROSS-REFERENCE TO RELATED APPLICATION

This application claims priority from Korean Patent Application No. 10-2013-0037344, filed on Apr. 5, 2013, in the Korean Intellectual Property Office, the disclosure of which is incorporated herein by reference, in its entirety.

### BACKGROUND

1. Technical Field

Aspects of the exemplary embodiments relate to a projection-type display device which forms an image through projection of a beam onto a screen.

2. Description of the Related Art

A projection-type display device forms an image by projecting light having image information onto a screen. Demand therefore is gradually increasing due to the advantages of a large-screen format.

In general, a projection-type display device includes a screen onto which light is projected, an optical engine to generate light having image information and to project the same onto the screen, and a driving circuit to drive an optical engine.

In the related art, an optical engine and driving circuit are disposed such that they are adjacent to each other in a single case. Accordingly, heat generated by the optical engine affects the driving circuit, which disadvantageously causes malfunction of the driving circuit, or heat generated by the driving circuit affects the optical engine, which disadvantageously causes deterioration of image quality. In addition, disadvantageously, material costs increase and noise become serious since a great number of cooling fans are required for cooling both the optical engine and the driving circuit.

### SUMMARY

Therefore, it is an aspect of the exemplary embodiments to provide a projection-type display device having an improved structure in order to effectively cool an optical engine so as to more efficiently and with lower cost generate light having image information and project the same onto a screen, and to provide improved cooling for a driving circuit to drive the optical engine.

It is another aspect of the exemplary embodiments to provide a projection-type display device having an improved structure to reduce noise.

Additional aspects of the exemplary embodiments will be set forth in part in the description which follows and, in part, will be obvious from the description, or may be learned by practice of the exemplary embodiments.

In accordance with an aspect of the exemplary embodiments, a display device includes a screen on which an image is configured to be formed, a stand configured to support the screen, an optical engine accommodated in the stand, the optical engine configured to generate light having image information and project the light onto the screen, a first heat-radiating plate connected to a rear surface of the screen, and a driving circuit connected to a rear surface of the first heat-radiating plate, the driving circuit being configured to drive the optical engine.

The optical engine may include a plurality of light sources configured to generate light, an illuminator configured to focus the light generated by the light sources, a display element configured to receive the light focused by the illuminator and generate light having image information, and a projector configured to project onto the screen the light having image information generated by the display element.

The light source may be a light emitting diode (LED).

The display device may further include a second heat-radiating plate connected to a rear surface of the light source, a third heat-radiating plate connected to a bottom of the stand, and a heat pipe to connect the second heat-radiating plate to the third heat-radiating plate.

The first heat-radiating plate may include a honeycomb-shaped structure.

The first heat-radiating plate may include a cylinder-shaped structure.

The first heat-radiating plate may include a wave-shaped structure.

The bottom of the stand may include a honeycomb-shaped structure.

The bottom of the stand may include a cylinder-shaped structure.

The bottom of the stand may include a wave-shaped structure.

The display device may further include at least one air intake fan disposed in one side of the stand, the air intake fan configured to draw exterior air into the stand, and at least one air discharge fan disposed in the other side of the stand, the air discharge fan configured to discharge interior air of the stand to the outside of the stand.

The illuminator and the projector may be disposed at different positions on the bottom of the stand.

The display device may further include a thermal pad to connect the first heat-radiating plate to the optical engine.

In accordance with another aspect of the exemplary embodiments, a display device includes a display body having a front surface provided with a screen, a stand configured to be connected to a lower part of the display body, the stand supporting the display body, an optical engine configured to be disposed in the stand, the optical engine configured to generate light having image information and project the light onto the screen, a driving circuit disposed in the display body, the driving circuit being configured to drive the optical engine, and at least one heat-radiating member disposed between the screen and the driving circuit, the heat-radiating member configured to absorb heat generated by the driving circuit and discharge the heat to the outside of the display body.

The heat-radiating member may include a first plate connected to the screen, a second plate connected to the driving circuit, and a heat-radiating structure disposed between the first plate and the second plate in order to increase a heat radiation area.

A material for the heat-radiating structure may include aluminum or an aluminum alloy.

The heat-radiating structure may have a honeycomb shape.

The heat-radiating structure may have a cylinder shape.

The heat-radiating structure may have a wave shape.

In accordance with another aspect of the exemplary embodiments, a display device includes a display body having a front surface provided with a screen, a stand configured to be connected to a lower part of the display body, the stand supporting the display body, an optical engine disposed in the stand, the optical engine including a plurality of light sources configured to generate light, an illuminator configured to focus the light generated by the light sources, a display element configured to receive the light focused by the illuminator and generate light having image information, and a projector configured to project onto the screen the light having image information generated by the display element, and at least one heat-radiator configured to transfer heat generated by the light source to the bottom of the stand, wherein the heat-radiator includes a first heat-radiating plate connected to a rear surface of the light source, a second heat-radiating plate connected to a bottom of the stand, at least one heat pipe to connect the first heat-radiating plate to the second heat-radiating plate and thereby transfer heat from the first heat-radiating plate to the second heat-radiating plate.

The bottom of the stand may include a honeycomb-shaped structure to increase a light radiation area.

The bottom of the stand may include a cylinder-shaped structure to increase a light radiation area.

The bottom of the stand may include a wave-shaped structure to increase a light radiation area.

An aspect of an exemplary embodiment may provide a display device including: a display body having a front surface provided with a screen; a stand connected to a lower part of the display body; an optical engine disposed in the stand; a driving circuit disposed in the display body, the driving circuit configured to drive the optical engine; a first heat-radiator disposed between the screen and the driving circuit, the heat-radiating member configured to absorb heat generated by the driving circuit and discharge the generated heat to the outside of the display body; and a second heat radiator including: a first heat-radiating plate connected to a rear surface of a light source; a second heat-radiating plate connected to a bottom of the stand; and at least one heat pipe configured to connect the first heat-radiating plate to the second heat-radiating plate and thereby transfer heat from the first heat-radiating plate to the second heat-radiating plate for discharge from the stand.

The optical engine may include: a plurality of light sources configured to generate light; an illuminator configured to focus the light generated by the light sources; a display element configured to receive the light focused by the illuminator and generate light having image information; and a projector configured to project onto the screen the light having image information generated by the display element.

The display device may further include: at least one air intake fan disposed in one side of the stand, the air intake fan configured to draw exterior air into the stand; and at least one air discharge fan disposed in the other side of the stand, the air discharge fan configured to discharge interior air of the stand to the outside of the stand.

### BRIEF DESCRIPTION OF THE DRAWINGS

These and/or other aspects will become apparent and more readily appreciated from the following description of the exemplary embodiments, taken in conjunction with the accompanying drawings of which:

FIG. 1 is a front perspective view which illustrates a display device according to one exemplary embodiment;

FIG. 2 is a rear perspective view which illustrates a display device according to one exemplary embodiment;

FIG. 3 illustrates accommodation of an optical engine and a driving circuit in a stand and a display body, respectively;

FIG. 4 is a plan view which illustrates the optical engine accommodated in the stand;

FIG. 5 is a side view of a part “A” of FIG. 3, which illustrates a connection relation between the driving circuit, a first heat-radiating member and a screen;

FIG. 6 is an enlarged perspective view which illustrates part “B” of FIG. 3, which illustrates a connection relation between a light source, a second heat-radiating member, a third heat-radiating member, and a stand bottom;

FIG. 7 illustrates a honeycomb-shaped heat-radiating structure included in the first heat-radiating member;

FIG. 8 illustrates a cylinder-shaped heat-radiating structure included in the first heat-radiating member; and

FIG. 9 illustrates a wave-shaped heat-radiating structure included in the first heat-radiating member.

### DETAILED DESCRIPTION OF THE EXEMPLARY EMBODIMENTS

Hereinafter, exemplary embodiments will be described with reference to the accompanying drawings.

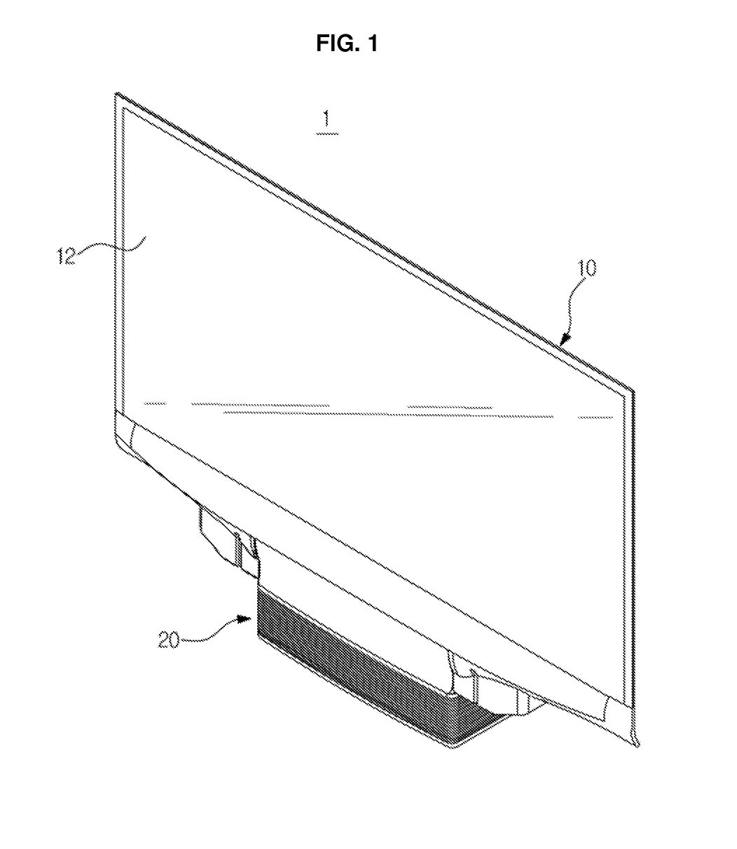

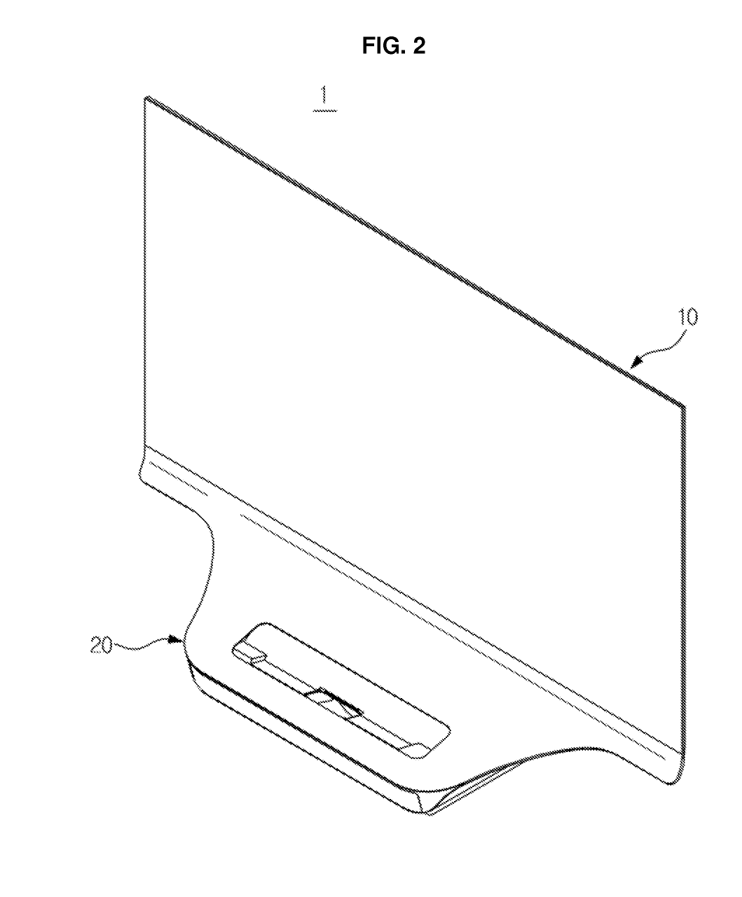

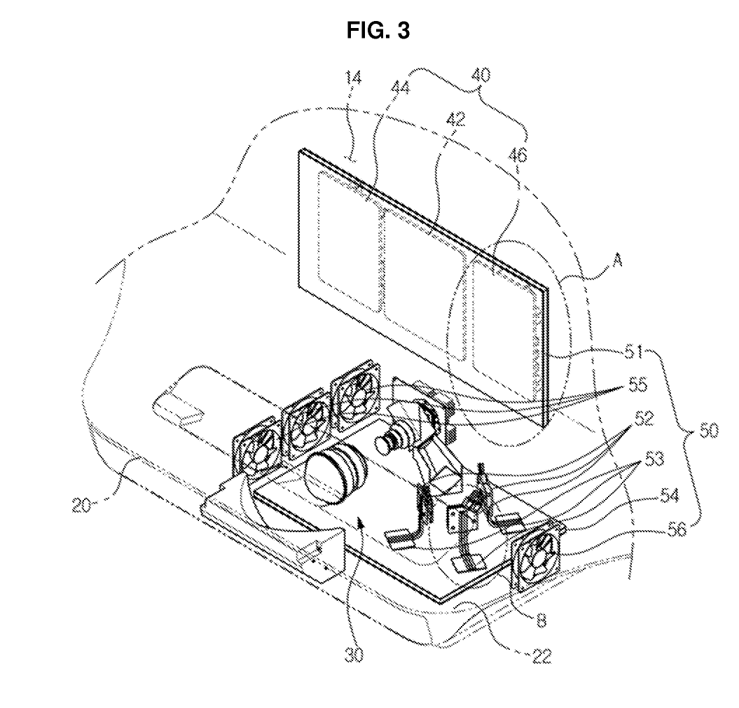

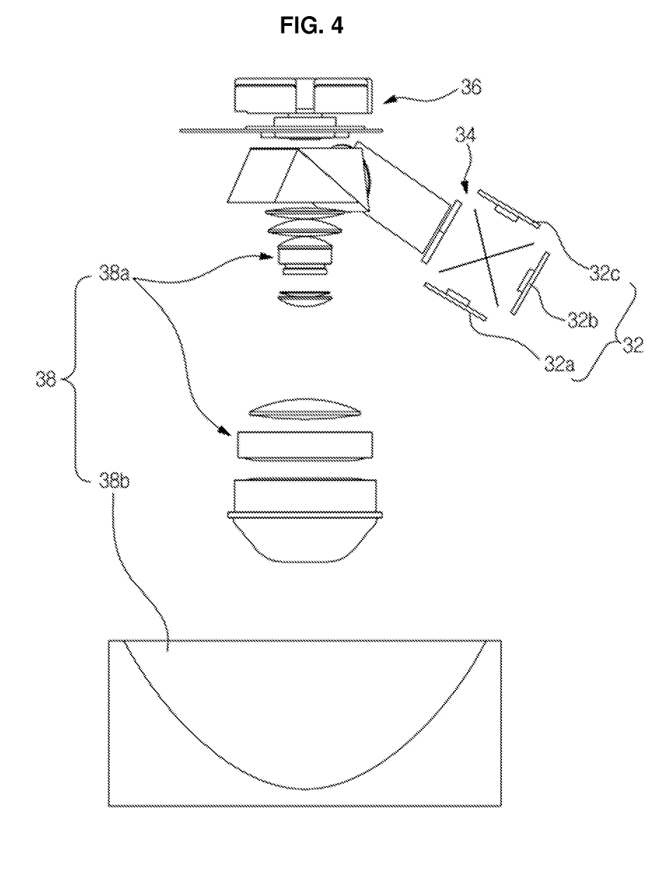

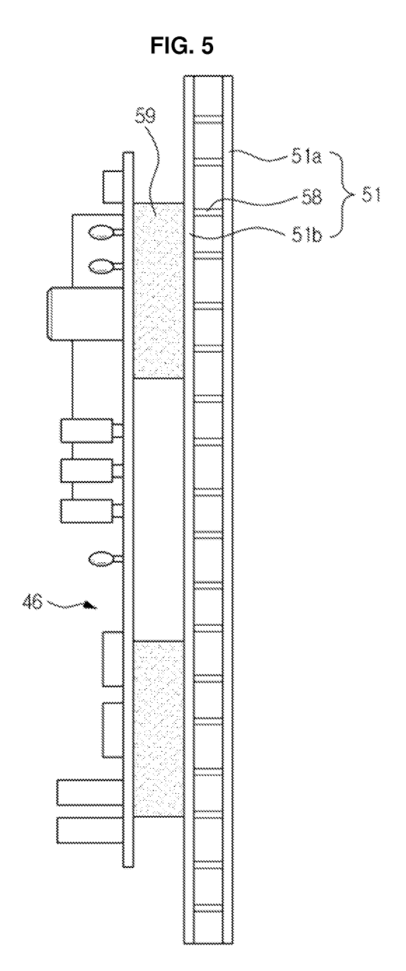

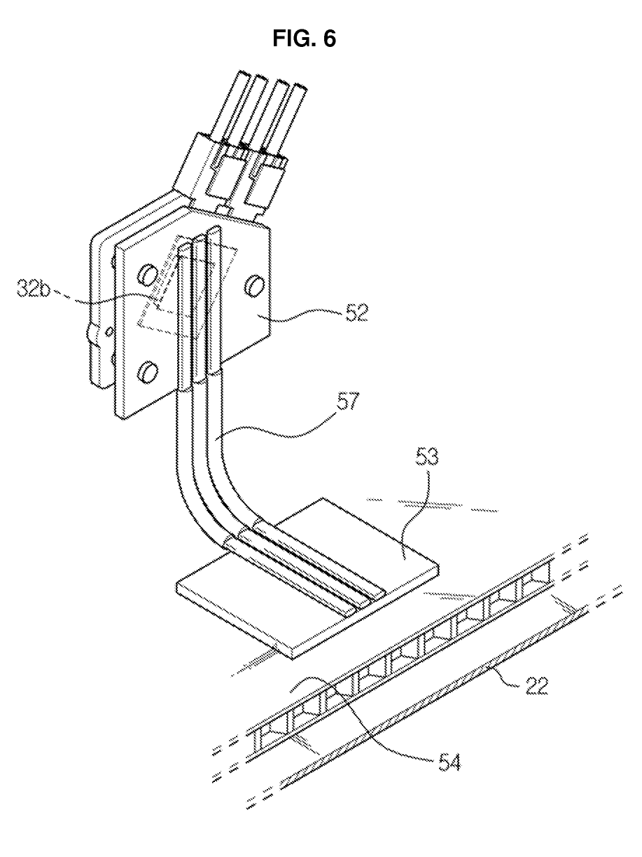

FIG. 1 is a perspective view which illustrates a display device according to an exemplary embodiment and FIG. 2 is a rear perspective view which illustrates a display device according to an exemplary embodiment. FIG. 3 illustrates accommodation of an optical engine and a driving circuit in a stand and a display body, respectively, and FIG. 4 is a plan view which illustrates the optical engine accommodated in the stand. FIG. 5 is a side view of part “A” of FIG. 3, which illustrates a connection relation between the driving circuit, a first heat-radiating member and a screen, and FIG. 6 is an enlarged perspective view which illustrates part “B” of FIG. 3, which illustrates a connection relation between a light source, a second heat-radiating member, a third heat-radiating member, and a stand bottom.

As shown in FIGS. 1 to 6, the display device 1 includes a display body 10, a stand 20 to support the display body 10, an optical engine 30 to form and project an image, a driving circuit 40 to drive the optical engine 30, and at least one heat-radiator 50 to absorb heat generated by the optical engine 30 and the driving circuit 40 and emit the heat to the outside of the display device 1.

A screen 12 is disposed on a front surface of display body 10. Light having image information formed by the optical engine 30 is projected onto the screen 12 and an image is formed thereon.

The stand 20 is connected to a lower part of the display body 10 to support the display body 10.

The optical engine 30 is disposed in the stand 20. The optical engine 30 includes a plurality of light sources 32 to generate light, an illuminator 34 to focus light generated by the light sources 32, a display element 36 to receive light focused by the illuminator 34 and generate light having image information, and a projector 38 to project onto the screen 12 light having image information generated by the display element 36.

The light sources 32 may be implemented with one or more light emitting diode (LED) modules and include at least one first LED module 32a emitting red light, at least one second LED module 32b emitting blue light, and at least one third LED module 32c emitting green light. The first LED module 32a and the second LED module 32b are disposed such that they face each other and the third LED module 32c is disposed between the first LED module 32a and the second LED module 32b. Positions of the second LED module 32b and the third LED module 32c may be interchangeable, as shown in FIG. 4.

The illuminator 34 includes at least one collimating lens (not shown) to focus light emitted from the first LED module 32a, the second LED module 32b and the third LED module 32c, and at least one condenser lens (not shown) to transmit and reflect the light focused by the collimating lens.

The display element 36 modulates light irradiated by the illuminator 34 and thereby generates light having image information. A digital micromirror device (DMD) panel, a liquid crystal panel, or the like, may be used as the display element 36.

The projector 38 enlarges light having image information generated by the display element and projects the light onto the screen 12, thus enabling formation of an image on the screen 12. The projector 38 includes a plurality of light-transmitting lenses 38a disposed in a row and in parallel, and a light-reflecting mirror 38b to enlarge and reflect light passing through the light-transmitting lenses 38a toward the screen 12.

The display element 36 is disposed in a row parallel to the projector 38 and the illuminator 34 is disposed at a side of the projector 38. The illuminator 34, the display element 36 and the projector 38 are disposed at different positions on the same plane. That is, the bottom 22 of the stand 20. Accordingly, a height of the stand 20 in this structure is lower than a structure in which the illuminator 34, the display element 36 and the projector 38 are disposed one above another.

The driving circuit 40 is accommodated in an accommodator 14 provided on the rear of the display body 10 and includes an LED driver 42 to control driving of the first LED module 32a, the second LED module 32b and the third LED module 32c used as the light sources 32, a switched-mode power supply (SMPS) 44 to supply power to the first LED module 32a, the second LED module 32b and the third LED module 32c and a DMD driving panel 46 to control driving of the display element 36.

As such, a phenomenon in which heat generated by the optical engine 30 affects the driving circuit 40 or heat generated by the driving circuit unit 40 affects the optical engine 30 is prevented, since the optical engine 30 and the driving circuit 40 are separately disposed in the display body 10 and the stand 20, respectively. In addition, an additional area to accommodate the driving circuit 40 in the stand 20 is not required and a space occupancy of an inner area of the stand in which the optical engine 30 is disposed thus increases.

Three colors of light emitted from the first LED module 32a, the second LED module 32b and the third LED module 32c are focused and reflected, or are focused and transmitted by the illuminator 34 and are irradiated to the display element 36. The light are modulated by the display element 36 to store image information and are enlarged and projected through the projector 38 to the screen 12 to form an image.

In the series of image formation process, heat generated by the first LED module 32a, the second LED module 32b and the third LED module 32c, and heat generated by the LED driver 42, the SMPS 44, the DMD driving panel 46, and the like, are discharged through the heat-radiator 50 to the outside of the display device 1.

The heat-radiator 50 includes a first heat-radiating member 51 to discharge heat generated by the driving circuit 40, that is, the LED driver 42, the SMPS 44, the DMD driving panel 46, and the like, to the outside of the display device 1, a second heat-radiating member 52 and a third heat-radiating member 53 to transfer heat generated by the first LED module 32a, the second LED module 32b and the third LED module 32c to a lower part of the stand 20, and a fourth heat-radiating member 54 to discharge heat transferred to the third heat-radiating member 53 to the outside of the display device 1.

The first heat-radiating member 51 is provided as a rectangular plate shape which substantially corresponds to the screen 12 and includes a first plate 51a disposed between the screen 12 and the driving circuit 40 in the display body 10 and connected to the rear surface of the screen 12, a second plate 51b connected to the LED driver 42, the SMPS 44 and the DMD driving panel 46, and a heat-radiating structure 58 provided between the first plate 51a and the second plate 51b. The first heat-radiating member 51 may be formed of aluminum (AL) or an aluminum alloy having superior thermal conductivity. A thermal pad 59 may be provided between the first heat-radiating member 51, and the LED driver 42, the SMPS 44 and the DMD driving panel 46 to firmly fix the first heat-radiating member 51, the LED driver 42, the SMPS 44 and the DMD driving panel 46, and to efficiently transfer heat generated by the LED driver 42, the SMPS 44 and the DMD driving panel 46 to the first heat-radiating member 51. The heat-radiating structure 58 has a configuration to increase a heat radiation area of the first heat-radiating member 51 and thereby improve heat radiation efficiency and a detailed description thereof will be given later. Heat generated by the LED driver 42, the SMPS 44 and the DMD driving panel 46 is effectively discharged to the outside of the display device 1 through the first heat-radiating member 51 having an area which corresponds to the screen 12. Although not illustrated, an element such as a cooling fan to further effectively discharge heat absorbed by the first heat-radiating member 51 to the outside of the display device 1 may be disposed around the first heat-radiating member 51.

The second heat-radiating member 52 is connected to and fixed on the rear surface of the first LED module 32a, the second LED module 32b and the third LED module 32c to absorb heat generated by the first LED module 32a, the second LED module 32b and the third LED module 32c. The third heat-radiating member 53 is connected to and fixed on the inner surface of the bottom 22 of the stand 20 to transfer heat transferred through the heat pipe 57 to the bottom 22 of the stand 20. The second heat-radiating member 52 and the third heat-radiating member 53 are provided to have a rectangular plate shape and are formed of aluminum (AL) or an aluminum alloy having superior thermal conductivity.

The second heat-radiating member 52 is connected to the third heat-radiating member 53 through the heat pipe 57. The heat pipe 57 transfers heat absorbed by the second heat-radiating member 52 to the third heat-radiating member 53. A liquid working fluid such as water, ethanol or acetone flows in the heat pipe 57. The working fluid is gasified in a region adjacent to the second heat-radiating member 52 having a relatively high temperature and absorbs heat of the second heat-radiating member 52, and the working fluid is liquefied in a region adjacent to the third heat-radiating member 53 having a relatively low temperature and absorbs heat of the third heat-radiating member 53.

The fourth heat-radiating member 54 is provided on the bottom of the stand 20, contacts the third heat-radiating member 53, receives heat of the third heat-radiating member 53 and discharges the heat to the outside of the display device 1. The fourth heat-radiating member 54 is formed of aluminum (AL) or an aluminum alloy having superior thermal conductivity.

The fourth heat-radiating member 54 is integrated with the bottom 22 of the stand 20. In this case, the bottom 22 of the stand 20 including the fourth heat-radiating member 54 functions to support the display body 10, the optical engine 30, or the like, to receive heat from the third heat-radiating member 53 and to discharge the heat to the outside of the display device 1.

In addition, the heat-radiator 50 includes at least one air intake fan 55 disposed in one side of the stand 20 and drawing exterior air into the stand 20, and at least one air discharge fan 56 disposed in the other side of the stand 20 and discharging interior air of the stand 20 to the outside of the stand 20. The air injected into the stand 20 through the air intake fan 55 exchanges heat with high-temperature air present in inner and outer regions and the neighborhood of the second heat-radiating member 52, the third heat-radiating member 53 and the fourth heat-radiating member 54 and is discharged through the air discharge fan 56 to the outside of the stand 20. In addition, the air intake fan 55 and the air discharge fan 56 draw exterior cold air into the stand 20 and discharge hot air present around the second heat-radiating member 52, the third heat-radiating member 53 and the fourth heat-radiating member 54 to the outside of the stand 20, respectively.

In addition, the first heat-radiating member 51 may be further provided with a separate structure to improve heat exchange efficiency.

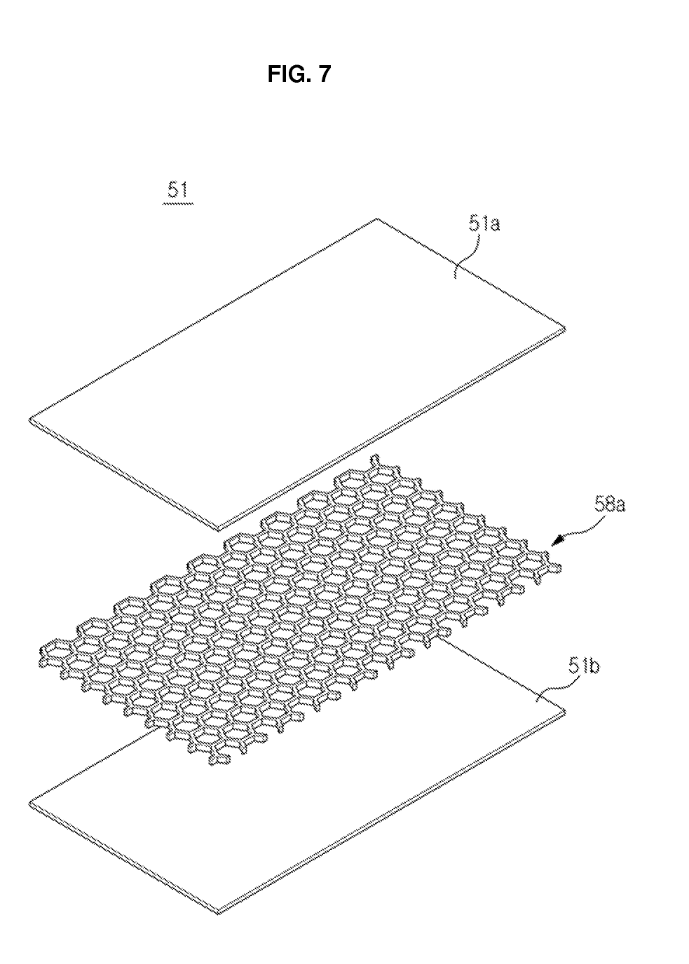

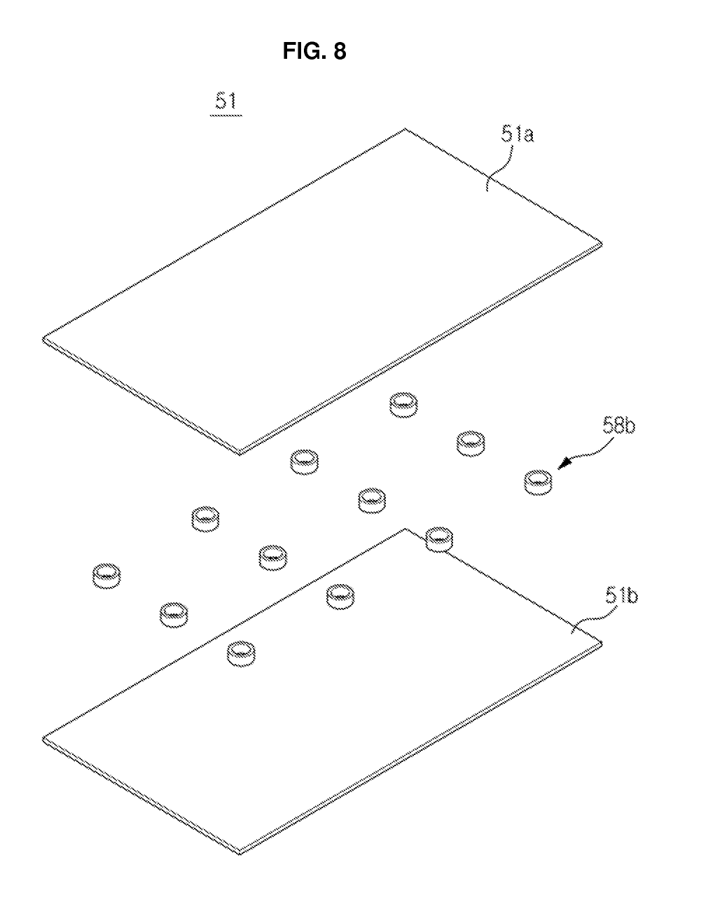

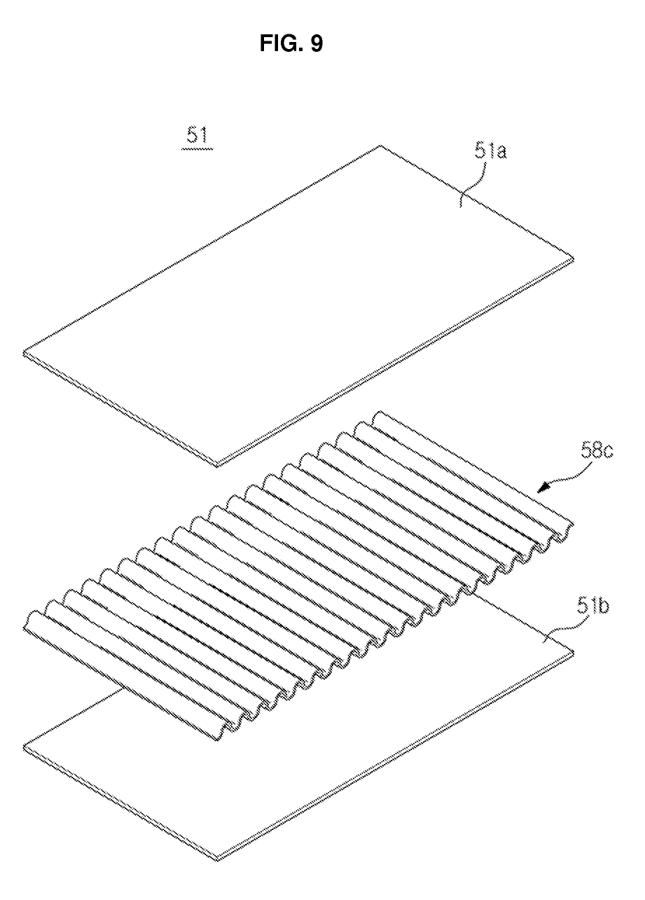

FIG. 7 illustrates a honeycomb-shaped heat-radiating structure included in the first heat-radiating member, FIG. 8 illustrates a cylinder-shaped heat-radiating structure included in the first heat-radiating member, and FIG. 9 illustrates a wave-shaped heat-radiating structure included in the first heat-radiating member.

As shown in FIGS. 7 to 9, the first heat-radiating member 51 may include a heat-radiating structure 58 such as honeycomb-shaped structure 58a, cylinder-shaped structure 58b or wave-shaped structure 58c.

The heat-radiating structure 58 increases a contact area between the first heat-radiating member 51 and air and further increases heat exchange efficiency. Furthermore, the heat-radiating structure 58 reinforces strength of the first heat-radiating member 51.

In addition, the honeycomb-shaped structure 58a, the cylinder-shaped structure 58b and the wave-shaped structure may be applied not only to the first heat-radiating member 51, but also to the second heat-radiating member 52, the third heat-radiating member 53 and the fourth heat-radiating member 54.

As apparent from the fore-going, in the display device 1 according to an exemplary embodiment, the optical engine 30 and the driving circuit 40 are separately disposed in the stand 20 and the display body 10, respectively, and separately radiate heat through the first to fourth heat-radiating members 51, 52, 53 and 54, thus improving cooling efficiency, reducing the number of fans as there is no need to cool the driving circuit 40 for the stand 20 and reducing noise.

In an exemplary embodiment, the optical engine and the driving circuit are separately disposed and cooled, and cooling efficiency is thus improved.

In addition, material costs are reduced and noise is reduced, since there is no need to mount a number of cooling fans.

In addition, since the driving circuit is accommodated in the display body, an additional area to accommodate the driving circuit t is unnecessary and the size of the display device is thus reduced.

Although a few exemplary embodiments have been shown and described, it would be appreciated by those skilled in the art that changes may be made in these exemplary embodiments without departing from the principles and spirit of the invention, the scope of which is defined in the claims and their equivalents.

What is claimed is:

1. A display device comprising:
a screen configured to have an image formed thereon;
a stand configured to support the screen;
an optical engine configured to be accommodated in the stand, the optical engine configured to generate light having image information and project the light onto the screen;
a first heat-radiating plate connected to a rear surface of the screen; and
a driving circuit connected to a rear surface of the first heat-radiating plate, the driving circuit configured to drive the optical engine.

2. The display device according to claim 1, wherein the optical engine comprises:
a plurality of light sources configured to generate light;
an illuminator configured to focus the light generated by the light sources;
a display element configured to receive the light focused by the illuminator and generate light having image information; and
a projector configured to project onto the screen the light having image information generated by the display element.

3. The display device according to claim 2, wherein the light source is a light emitting diode (LED).

4. The display device according to claim 2, further comprising:
a second heat-radiating plate connected to a rear surface of the light source;
a third heat-radiating plate connected to a bottom of the stand; and
a heat pipe configured to the second heat-radiating plate to the third heat-radiating plate.

5. The display device according to claim 1, wherein the first heat-radiating plate comprises a honeycomb-shaped structure.

6. The display device according to claim 1, wherein the first heat-radiating plate comprises a cylinder-shaped structure.

7. The display device according to claim 1, wherein the first heat-radiating plate comprises a wave-shaped structure.

8. The display device according to claim 4, wherein the bottom of the stand comprises a honeycomb-shaped structure.

9. The display device according to claim 4, wherein the bottom of the stand comprises a cylinder-shaped structure.

10. The display device according to claim 4, wherein the bottom of the stand comprises a wave-shaped structure.

11. The display device according to claim 1, further comprising:
at least one air intake fan disposed in one side of the stand, the air intake fan configured to draw exterior air into the stand; and
at least one air discharge fan disposed in the other side of the stand, the air discharge fan configured to discharge interior air of the stand to the outside of the stand.

12. The display device according to claim 2, wherein the illuminator and the projector are disposed at different positions on the bottom of the stand.

13. The display device according to claim 1, further comprising a thermal pad configured to connect the first heat-radiating plate to the optical engine.

14. A display device comprising:
a display body having a front surface provided with a screen;
a stand connected to a lower part of the display body, the stand supporting the display body;
an optical engine disposed in the stand, the optical engine configured to generate light having image information and project the light onto the screen;
a driving circuit disposed in the display body, the driving circuit configured to drive the optical engine; and
at least one heat-radiating member disposed between the screen and the driving circuit, the heat-radiating member configured to absorb heat generated by the driving circuit and to discharge the generated heat to the outside of the display body.

15. The display device according to claim 14, wherein the heat-radiating member comprises:
a first plate connected to the screen;
a second plate connected to the driving circuit; and
a heat-radiating structure disposed between the first plate and the second plate to increase a heat radiation area.

16. The display device according to claim 15, wherein a material for the heat-radiating structure comprises aluminum or an aluminum alloy.

17. The display device according to claim 15, wherein the heat-radiating structure has a honeycomb shape.

18. The display device according to claim 15, wherein the heat-radiating structure has a cylindrical shape.

19. The display device according to claim 15, wherein the heat-radiating structure has a wave shape.

20. A display device comprising:
a display body having a front surface provided with a screen;
a stand connected to a lower part of the display body, the stand configured to support the display body;
an optical engine disposed in the stand, the optical engine comprising a plurality of light sources configured to generate light, an illuminator configured to focus the light generated by the light sources, a display element configured to receive the light focused by the illuminator and generate light having image information, and a projector configured to project the light having image information generated by the display element onto the screen; and
at least one heat-radiator configured to transfer heat generated by the light source to the bottom of the stand,
wherein the heat-radiator comprises:
a first heat-radiating plate connected to a rear surface of the light source;
a second heat-radiating plate connected to a bottom of the stand;
at least one heat pipe configured to connect the first heat-radiating plate to the second heat-radiating plate and thereby transfer heat from the first heat-radiating plate to the second heat-radiating plate.

21. The display device according to claim 20, wherein the bottom comprises a honeycomb-shaped structure to increase a light radiation area.

22. The display device according to claim 20, wherein the bottom comprises a cylinder-shaped structure to increase a light radiation area.

23. The display device according to claim 20, wherein the bottom comprises a wave-shaped structure to increase a light radiation area.

24. A display device comprising:
a display body having a front surface provided with a screen;
a stand connected to a lower part of the display body;
an optical engine disposed in the stand;
a driving circuit disposed in the display body, the driving circuit configured to drive the optical engine; and
a first heat-radiator disposed between the screen and the driving circuit, the heat-radiating member configured to absorb heat generated by the driving circuit and discharge the generated heat to the outside of the display body; and
a second heat radiator comprising:
a first heat-radiating plate connected to a rear surface of a light source;
a second heat-radiating plate connected to a bottom of the stand;
at least one heat pipe configured to connect the first heat-radiating plate to the second heat-radiating plate and thereby transfer heat from the first heat-radiating plate to the second heat-radiating plate for discharge from the stand.
